(19) United States
(12) Patent Application Publication
(10) Pub. No.: US 2004/0036694 A1
(43) Pub. Date: Feb. 26, 2004

(54) Method and system for processing a color conversion table

(76) Inventor: Klaus Hirtenreiter, Eching (DE)

Correspondence Address: SCHIFF HARDIN & WAITE, 6600 SEARS TOWER, 233 S WACKER DR, CHICAGO, IL, 60606-6473, US

(21) Appl. No.: 10/221,801

(22) PCT Filed: Apr. 9, 2001
(86) PCT No.: PCT/EP01/04058

(30) Foreign Application Priority Data
Apr. 10, 2000 (GB) 100 17 831.6

(51) Int. Cl. G09G 5/02

(52) U.S. Cl. 345/601

(57) ABSTRACT

A method and system checks or processes a color conversion table with which at least one source color value of a source color space is converted into at least one target color value of a target color space. The source color allocated to a source color value in the source color space is graphically displayed on a display device in a first display area. A target color allocated to a target color value in the target color space is graphically displayed in a second display area. The source color value and the corresponding target color value, the source color and the corresponding source color value, and the target color and the corresponding target color value are displayed line-by-line or column-by-column in a common table. Respective text designations in the table are allocated to the displays of the target color and the source color.

The invention is directed to a method, a system and a computer program for checking and processing a color conversion table. Such color conversion tables, what are referred to as color mapping tables (CMT), are used, among other things, in printing systems in order to introduce those colors that are best suited for the print-oriented reproduction of a document instead of the original colors of the document.

Dependent on what color scope the print data processing devices, particularly the ultimately employed printer devices, have, it is desirable or necessary to convert the original colors into similar or into different printing colors.

What is advantageous in the employment of color conversion tables is that the document itself, i.e. the original print data, need not be modified for the color conversion with the assistance of the color conversion tables.

In color printing, print data are usually described within specific color models. Known color models are the red-green-blue color model (RGB), the cyan-magenta-yellow-black color model (CMYK) as well as the CIELAB color model in which the colors are described with three components having a respective length of eight bits (one byte). In the CIELAB model, the first component (luminance) describes the intensity of the color; the two other components (a and b) describe coordinates in a two-dimensional color space.

The color models 'standard OCA Color” and “GOCA pattern Fill” are also employed in the graphic field, a limited plurality of colors (palettes) and patterns being respectively defined therein. In electrographic color printing, what is referred to as the Highlight Color color model is also of significance, a limited number of colors, particularly only two colors, being likewise described therein as components.

In highlight color printing, ip, three components are employed for describing a color value. The first component is a 2-byte binary number that represents the number of the color. The standard color of the printing system (black) as well as at least one additional color (highlight color) can thus be described. The degree of coverage of the respective color can be described in percent with a second component. An additional shading of the highlight color can be optionally recited with a third component, this corresponding to a certain admixture of the basic color (black) in percent.

Color conversion tables are preferably utilized in high-performance printing systems with printing speeds of 40 to more than 1000 DIN A4 pages per minute.

Print data streams in the data formats “Advanced Function Presentation” (AFP) and “Mixed Object Document Content Architecture” (MO:DCA) are preferably utilized in such printing systems. For example, the MO:DCA specification is described in document number SC31-6802-04 (August 1997) of International Business Machines (IBM). Color conversion tables (color mapping tables) are defined and specified on pages 383 through 387 of this document. This document is herewith incorporated by reference into the present specification.

In the aforementioned print data formats, print data are divided into variable data that occur document-individually or, respectively, page-individually and into what are referred to as resources that occur more often within a document or over a plurality of documents. The employment of such resources then means that the resource data in the print job need be transmitted only once to a printer that supports such data streams. Within the printer, the resource data can then be called by corresponding references within the variable data stream and can be multiply employed in the printing event. Color conversion tables can thereby likewise be transmitted into the printing system as non-printing resource in what is referred to as an object container with object identifier and name. To this end, the color conversion table is available in a document-specific resource packet or in an external resource library on the host system. A standard color conversion table can thereby also be allocated in the output process.

According to the aforementioned MO:DCA specification, the color conversion table is composed of a table header that specifies whether it is a matter of a conversion table or of a reset table. In a conversion table, color conversion values are indicated in a plurality of what are referred to as repetition groups. In a reset table, any color conversion is deactivated, i.e. an incoming print data stream is forwarded unmodified.

U.S. Pat. No. 5,627,950 discloses a method and a system according to the preamble of the independent claims. A source color is presented on a display device in one section thereof and a target color allocated to this source color is displayed in another section thereof. Further, a three-dimensional color model is presented on the display device. A user can vary color locations of the color model with on-line editing, whereupon the displayed target color value also changes in terms of its presentation.

Further, EP-A-0 333 475 and WO 92/20024 A disclose that text designations be allocated to color values.

The publication “A System for WYSIWYG color communication”, Peter A. Rhodes and Ronnier Lou, Displays Vol. 16 No. 4, 1996, pages 213 through 221 discloses a method and a system with which graphically supported color conversions can ensue between different color systems.

The publication “Farbliche Produktionssicherheit im Druck beginnt in der Druckvorstufe”, Dieter Kleeberg, Polygraph, 1995, pp. 32-34 discloses that measured color values of a master color and recipe values for a printing process be displayed in various display regions on a monitor.

U.S. Pat. No. 237,517 discloses that color image values be converted into highlight color image values of a printer device.

U.S. Pat. No. 5,982,924 discloses a method and a system with which color images can be reproduced in a limited two-color space. US-H-1506 discloses a graphic user interface with which a color palette can be processed.

An object of the invention is to be able to produce and/or process color conversion tables with which at least one source color value of a source color space is converted into at least one target color value of a target color space in as simple and dependable a way as possible.

This object is achieved by the invention described in the independent patent claims. Advantageous developments of the invention are the subject matter of the subclaims.

Inventively, a color conversion table with which at least one source color value of a source color space can be converted into at least one target color value of a target color space is visualized on a display device. A display of a source color that is allocated to a source color value in the source color space thereby ensues such in a graphically allocated, visually discernable way that its allocation to a graphic display of the target color that is allocated to a target color value in the target color space is visually possible.

The invention is based on the perception that it is significantly simpler for a user producing or, respectively, modifying a color conversion table to implement this production or, respectively, conversion with a graphically supported supply instead of merely with abstract numerical values. As a result of the graphic display of the source color and/or of the target color, it is possible to display colors on a picture screen that correspond exactly to the color values (particularly given RGB colors and CMYK colors). However, it is just as easily possible to present the graphic display from a prescribed palette of display colors that do not exactly correspond to the color that is encoded by its color value in the corresponding color space.

A further aspect of the invention can thereby be advantageously utilized in accord wherewith the graphic presentation of the source color and/or of the target color is provided with an arbitrary text designation in graphic allocation. This aspect of the invention can be especially advantageously employed in what are referred to as allocations of highlight colors of print data streams because such highlight colors definitely can contain colors that [. . . ] in a standard color space that cannot be presented by a standard palette of display colors (for example, in a Windows operating system for personal computers). The designation of the color, for example “OCE WARM RED”, and presentation of a display color similar to this color can thereby be advantageously exploited.

Exemplary embodiments of the invention are described in greater detail below on the basis of some Figures:

Shown are:

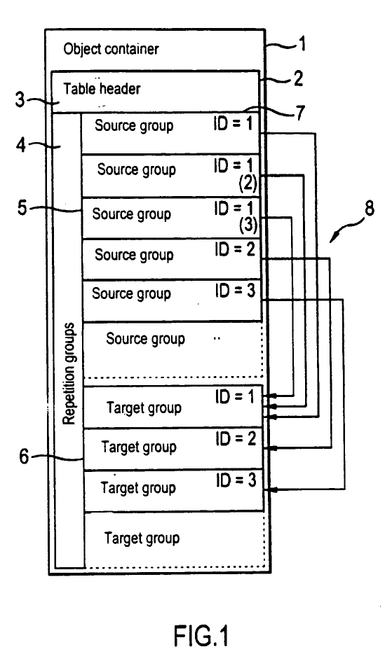

FIG. 1 the structure of a color conversion table;

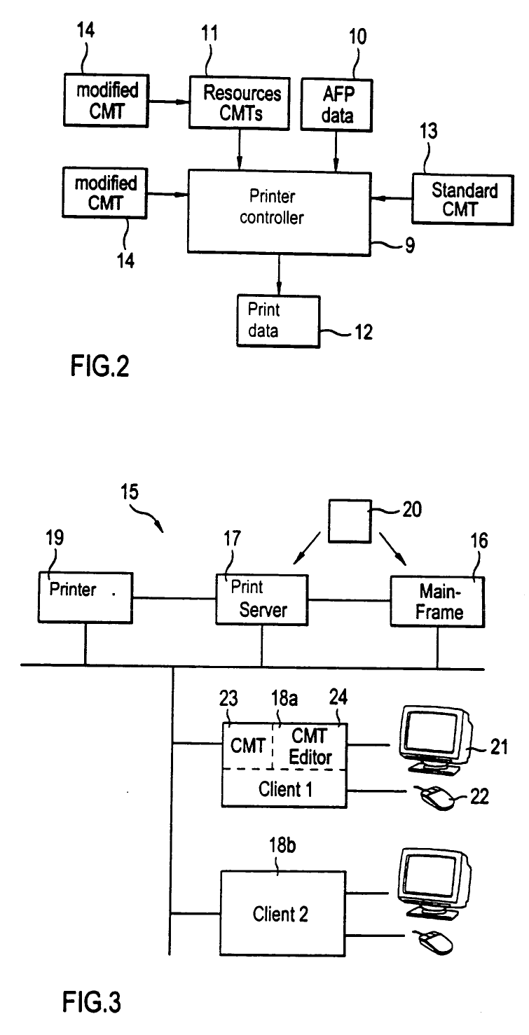

FIG. 2 a data flow in a printing environment;

FIG. 3 a printing system;

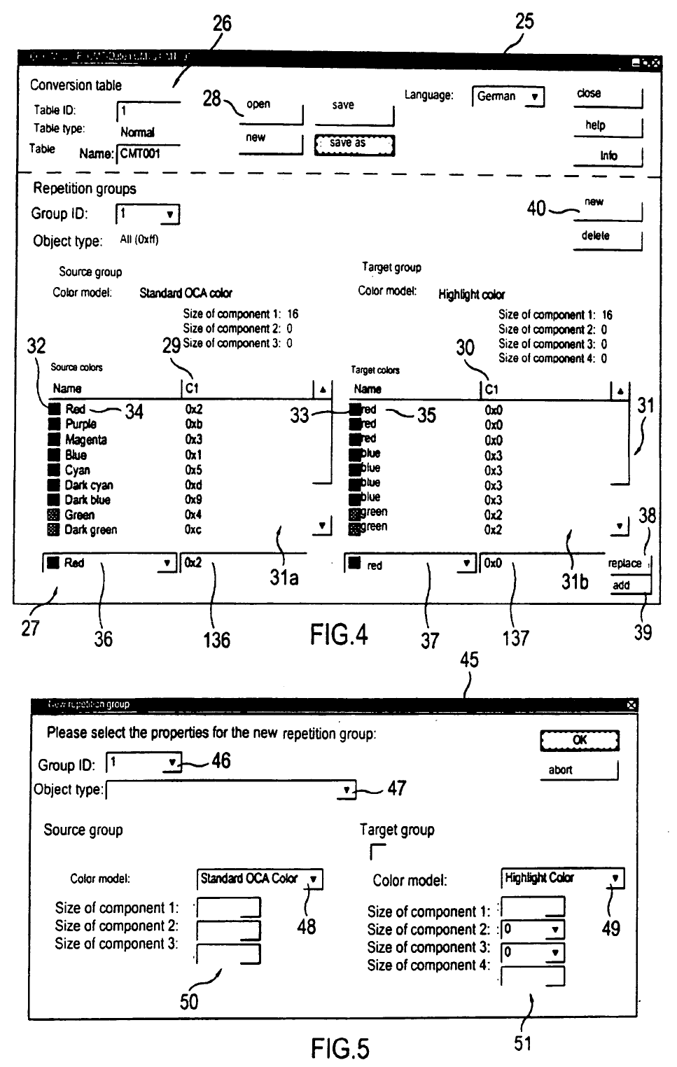

FIG. 4 a processing menu for color conversion tables;

FIG. 5 a processing menu for a new repetition group;

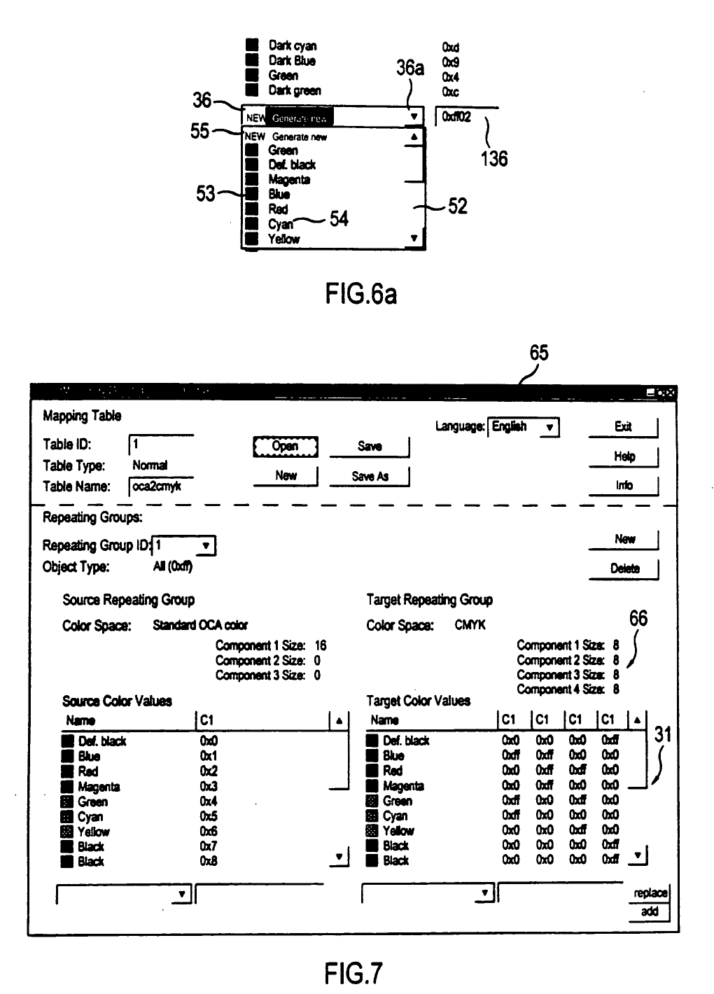

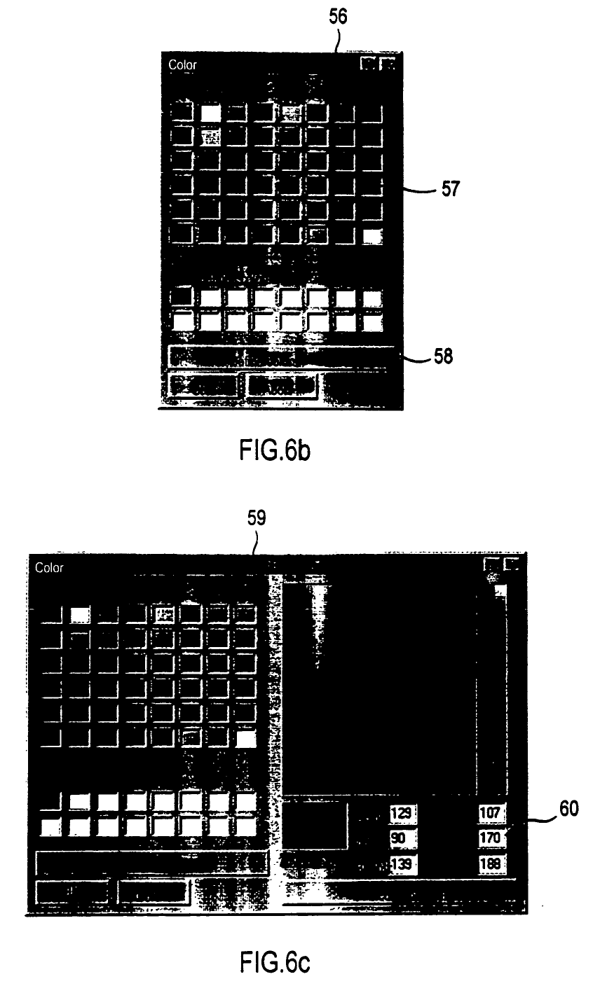

FIG. 6 menus for color settings; and

FIG. 7 an expanded processing menu for color conversion tables.

FIG. 1 shows the structure of a color conversion table 2 linked into a resource object container 1. Said color conversion table 2 is composed of a table header 3 and of a plurality of repetition groups 4. The repetition groups 4 are in turn subdivided into a plurality of source groups 5 and target groups 6. The source groups and the target groups are respectively listed with an ascending identifier (ID) 7 in the color conversion table 2. Each source group 5 has exactly one target group 6 allocated to it. In contrast, a target group can have a plurality of source groups allocated to it. The logical allocation 8 shows, for example, that the target group having the identification number ID=1 has three source groups with the identifications ID=1, ID=1 (2) and ID=1 (3) allocated to it.

During the course of a printing process, a color conversion table called in a printer controller or a print server remains active until a different color conversion table or a reset table that deactivates the color conversion process is called.

FIG. 2 shows a data flow that can run within a printer controller 9 or in a data processor of a print server in a printing process or, respectively, in an inventive printing system. The variable print data 10 of an AFP print data stream are thereby supplied together with corresponding resource data 11 to the print processor 9 in which the data are converted into a print data stream 12 with which a specific printer can be driven.

Color conversion tables (color mapping tables, CMT) are thereby integrated or can thereby be integrated at various locations of the process run. Standard color conversion tables 13, for example, can be provided in the resource data stream 11 or at the printer controller 9, as well. As an alternative thereto, modified color conversion tables 14 can be linked into said data streams or printer controller 9.

FIG. 3 shows a print production system 15 that is composed of a plurality of system components that connects [sic] a plurality of computers, at least one printer and potential print pre-processing devices such a spoolers or print post-processing devices such as sorting devices in data-oriented terms via a computer network, for example via a local area network (LAN), by means of a standard network protocol such as TCP/IP or token ring. Print data, for example in the AFP format, can thereby be offered for printing by a host computer 16, a tape store 20, a print server 17 or by connected workstation computers (clients) 18.

For example, a color conversion table 23 is loaded in a main memory in the client 18a. This is processed with a color conversion table processing program 24.

The processing ensues by means of a mouse 22 and graphic displays on the picture screen 21.

FIG. 4 shows the main window 25 of the processing program 24. This is composed of two areas, whereby particulars and selection possibilities for the conversion table exist in the area 26, for instance table identification number, table type (normal or reset table) as well as a table name (CMT001).

The conversion tables can be managed with notoriously known buttons such as “new”, “open” (28), “save”.

Information and setting possibilities about the repetition groups are provided in the second area 27. The processing program 24 thus makes it possible to simply and quickly produce or process color conversion tables. The graphic user interface opens up the program functions in a largely self-explanatory way. Proceeding from the main window 25, further dialogue windows can be selected for compiling a new color conversion table or a new repetition group. All determinations that are made within the dialogue window that is offered are automatically converted into consistent color conversion tables according to the selected color models and in their syntax. A plausibility check can thereby be performed to see whether the determinations that are input are permitted within the selected color model.

The color conversion table is deposited in a datafile that can be offered as resource in a print job or can be transmitted directly to the printing system as standard conversion table. A color conversion table that has already been produced can be loaded into the processing program 24 via the button 28 “open”, and the corresponding settings can be displayed in the area 27. The basis for processing the repetition groups is thereby formed by the display area 31 whose left part 31a indicates the values for the source colors and whose right part 31b indicates the values for the target colors. The presentation thereby ensues line-by-line, so that the first source color value 0×2 indicated in column 29 is converted into the first target color value 0×0 indicated in column 30. The allocation between source color value and target color value can be unambiguously recognized as a result of the line-by-line presentation of the source color values and of the appertaining target color values in the display area 31 in a table-like presentation. As an alternative to this type of allocation in lines, a column-by-column allocation or an allocation with symbols such as, for example, arrows could also ensue.

In the example shown in FIG. 4, the source group in the standard OCA color model is converted to a target group in the highlight color model, whereby the target group has exactly one component (C1) with the size 16. The components 2 through 4 are unused in this case. In a color conversion table of the Prior Art, only the color values in the columns 29 or, respectively, 30 would be indicated. Inventively, it is provided that both a graphic display in columns 32 or, respectively, 33 as well as a corresponding text designation in columns 34 or, respectively, 35 be allocated to the color values indicated in the columns 29 and 30.

The allocation that ensues between a color value residing in column 29, its graphic color presentation visible in the color display field 28 and its text field 34 can be arbitrarily varied via the setting field 36. An allocation of a target color value entered in column 30 to the corresponding color display field 33 and its text field 35 can be modified in exactly the same way via the setting surface 37 and the button 38.

Proceeding from the allocations to a source color, the settings can be undertaken in the appertaining source color fields and target color fields. To that end, the desired source color is selected in column 34, whereupon the values and displays of this source color and the target color allocated to it are transferred into the editing fields 36 and 136 or, respectively, 37 and 137. Both the graphic color allocation, the text allocation as well as the color values themselves can then be modified there for the source color and/or for the corresponding target color. The color selection list 52 shown in FIG. 6a is thereby displayed, both the graphic color allocation as well as the text allocation of the selected source or, respectively, target color value being recognizable therein. By actuating the button “replace” (FIG. 4), the color conversion previously selected in column 34 is replaced by the modified color conversion in the editing fields 36, 136, 37 and 137.

Corresponding to the procedure for modifying color values that has just been described, new values for the source or target group can be defined via the button 39 “add”, whereby a new entry ensues into the column 30 and correspondingly allocated, new entries ensue into the fields 35, 36.

In order to generate a new repetition group, the button 40 in the main window 25 is actuated. As a result thereof, the repetition group window 45 shown in FIG. 5 is opened. The identification number of the group (ID) can be selected in a setting surface 46. The type or, respectively, the group of the object type data of the source document for which the color conversion is to apply is selected in the selection field 47 (object type). The standard setting is “all”, whereby specific objects such as image data, overlay presentation levels or IOCA data according to the aforementioned MO:DCA specification can be selectively elected. Given a selective election, the color conversion table is employed only for the selected object types and is deactivated in view of other object types.

Various color models for the source group and for the target group can be selected in the selection fields 48 and 49.

Finally, the size of the presentation components can be selected in the selection fields 50 and 51. The size of the components is respectively rigidly prescribed for the color models CMYK, RGB and CIELAB because their color allocations are unambiguous. Whether the presentation components 2 and 3 are to be used and the bit plurality with which they should respectively ensue can, however, be selected for the color model Highlight Color.

FIG. 6a shows how the selection of display field allocations of the display fields 32 ensues via the selection surface 36. The actuation of the arrow key 36a opens a selection list 52 in which already defined allocations of display color surfaces 53 and color designations 54 are offered. After selection of a color designation 54, the appertaining color values are automatically displayed in the setting fields 36 and 136 or, respectively, 37 and 137. This automatic display makes it possible, on the one hand, for the user to easily check or select allocations that already exist. On the other hand, the values recited in the corresponding fields 53, 54 or 136 can be arbitrarily modified and the modified values can be accepted (38) by subsequent actuation of the buttons 38 or, respectively, 39 or a new combination can be produced. If no suitable selection is possible in the palette of colors and color designations present in the list 52, a new display color surface and a new color designation connected therewith can be produced via the selection 55, “generate new”. A color selection dialogue offered by the operating system (Windows) is employed for this purpose; this, for example, can be offered and called in a standard way under the Windows operating system.

When the palette of basic colors offered in the color dialogue 56 in the color surfaces 57 is inadequate, the expanded color dialogue 59 offered as a standard feature in Windows can be called. The color dialogues 56 and 59 are offered, for example, under the class “CColorDialog” in the common controls library in the programming environment MS Visual C++®. When numerical values for the color values are input in the color value setting dialogues 60, then the editing program 24 immediately checks to see whether these setting values are in fact supported within the framework of the currently loaded repetition group, i.e. in the color model of the source group or, respectively, in the color model of the target group. When this is not the case, then an alarm is output or an automatic correction in the direction of the closest allowable color value is undertaken.

FIG. 7 again shows a main menu window 65 wherein a color conversion table having the name “OCA2CMYK” is loaded. The course group is thereby again defined in the standard OCA color model but the target group is defined in the CMYK color model. Since all four components 66 are required in this CMYK color model, respectively four columns for the four components (C1, C2, C3, C4) are also offered for setting in the region 31.

In summary, it can be reiterated that the present invention improves the employment of inherently known color conversion tables to the effect that the color conversion tables are expanded with respect to their informational content. In addition to the known particulars from which a source color value is converted into a target color value, a graphic display field, particularly in an arbitrary color, is inventively additionally allocated to each source color value and an allocation that is just the same is undertaken for the target color values. In particular, colors that are a standard offering under an operating system are offered for the graphic display fields, for example RGB colors that are standard under Windows. Values corresponding to the allocations are stored in the expanded color conversion table and are logically allocated to one another. The color conversion table expanded in this way makes it significantly easier for users to produce and modify color conversion tables. As a result thereof, a flexible adaptation to exigencies of color printing can ensue, particularly in the conversion of color materials or given the selection of new printing systems.

Exemplary embodiments of the invention have been described. It is thereby clear that a person skilled in the art can recite further developments of the invention at any time. For example, the monitoring and correction of incorrectly input color values can be further-automated.

The invention can be realized as a computer program or as a computer program product integrated in a computer or can also be realized as a datafile that can be stored on a data carrier or transmitted via networks such as the Internet. Its application is particularly advantageous in printing systems with connected print servers.

List of Reference Characters

| | |
|---|---|
| 1 | resource object container |
| 2 | color conversion table (color mapping table, CMT) |
| 3 | table header |
| 4 | repetition groups |
| 5 | source groups |
| 6 | target groups |
| 7 | group identifier |
| 8 | group allocation |
| 9 | printer controller |
| 10 | variable print data |
| 11 | resource data |
| 12 | print data stream |
| 13 | standard CMT |
| 14 | modified CMT |
| 15 | print production system |
| 16 | host computer |
| 17 | print server |
| 18 | client computer |
| 19 | printer |
| 20 | print data memory (archive) |
| 21 | monitor |
| 22 | mouse |
| 23 | loaded color conversion table |
| 24 | CMT processing program |
| 25 | main window |
| 26 | area for conversion tables |
| 27 | area for repetition groups |
| 28 | “open” button |
| 29 | column for source color values |
| 30 | column for target color values |
| 31 | display area for conversion values |
| 32 | color display field allocated to the source color value |
| 33 | color display field allocated to the target color value |
| 34 | text field allocated to the source color value |
| 35 | text field allocated to the target color value |
| 36 | setting surface for source color |
| 37 | setting surface for target colors |
| 38 | “replace’ button |
| 39 | “add” button |
| 40 | “new repetition group” button |
| 45 | repetition group window |
| 46 | “group ID” setting surface |
| 47 | “object type’ setting surface |
| 48 | selection field for color model of source group |
| 49 | selection field for color model of target group |
| 50 | selection field “component size” for source group |
| 51 | selection field “component size” for target group |
| 52 | color selection list |
| 53 | defined display color surface |
| 54 | defined color designations |
| 55 | “new color” button |
| 56 | color field dialogue |
| 57 | color surfaces |
| 58 | color button |
| 59 | expanded color dialogue window |
| 60 | color value setting dialogues |
| 65 | main menu window |
| 66 | color components |
| 136 | editing field for source color |
| 137 | editing field for target color |

1. Method for checking and/or processing a color conversion table (color mapping table) with which at least one source color value of a source color space (standard OCA color) can be converted into at least one target color value of a target color space (highlight color), whereby
a graphic display of a source color that is allocated to a source color value in the source color space ensues on a display device (monitor) in a first display area (31a),
a graphic display of a target color that is allocated to a target color value in the target color space ensues in a second display area (31b) of the display device (monitor),
characterized in that the display of the source color value and of the appertaining target color value, of the source color and of the appertaining source color value as well as of the target color and the appertaining target color value respectively ensues line-by-line or column-by-column in a common table; and
respective text designations in the table are allocated to the displays of the target color and of the source color.

2. Method according to claim 1, whereby source color values and/or target color values are produced or modified.

3. Method according to claim 1 or 2, whereby the graphic display of the source color and/or of the target color is selected, particularly from a prescribed palette of display colors.

4. Method according to one of the preceding claims, whereby the color conversion table (CM T) is employed for the conversion of a print data stream (10, 11).

5. Method according to claim 4, whereby the converted print data stream has only two color allocations (highlight color).

6. Method according to claim 4 or 5, whereby the converted print data stream is employed in a printer device for the drive of a plurality of color printing units.

7. Method according to claim 6, whereby the printer device is a highlight color printer device.

8. Method according to one of the claims 4 through 7, whereby the print data stream (10, 11) is a data stream (AFP, MO:DCA) divided according to variable data and resources and wherein color particulars for printing information (objects) ensue by means of color values that correspond to the source color values.

9. Method according to one of the preceding claims, whereby the target color values are selected adapted to a target printer (19) employed for printing the print data stream.

10. Method according to one of the preceding claims, whereby the color conversion table is divided into repetition groups that contain source color values for specific source groups and target color values for specific target groups.

11. Method according to one of the preceding claims, whereby exactly one target color value is allocated to the source color value.

12. System for checking and/or processing a color conversion table (color mapping table) with which at least one source color value of a source color space (standard OCA color) can be converted into at least one target color value of a target color space (highlight color), whereby
a graphic display of a source color that is allocated to a source color value in the source color space ensues on a display device (monitor) in a first display area (31a),
a graphic display of a target color that is allocated to a target color value in the target color space ensues in a second display area (31b) of the display device (monitor),
characterized in that the display of the source color value and of the appertaining target color value, of the source color and of the appertaining source color value as well as of the target color and the appertaining target color value respectively ensues line-by-line or column-by-column in a common table; and
respective text designations in the table are allocated to the displays of the target color and of the source color.

13. Computer program that effects a method execution according to one of the claims 1 through 11 on a computer.
